(19) United States
(12) Patent Application Publication
(10) Pub. No.: US 2024/0054818 A1
(43) Pub. Date: Feb. 15, 2024

(54) SMART WIRELESS REMOTE-CONTROL DEVICE WITH RECOGNITION FUNCTION

(71) Applicant: NEURONBASIC TECHNOLOGY INC., Santa Clara, CA (US)

(72) Inventor: Raymond WU, Santa Clara, CA (US)

(21) Appl. No.: 17/818,507

(22) Filed: Aug. 9, 2022

(51) Int. Cl. G06V 40/20; G08C 17/02; G08C 23/04

(52) U.S. Cl. CPC G06V 40/28; G08C 17/02; G08C 23/04; G08C 2201/32

(57) ABSTRACT

The present invention is a smart wireless remote-control device with image recognition function. The remote-control device mainly includes an image recognition mechanism, which is electrically connected to a signal transmission mechanism. The image recognition mechanism is composed of a camera lens unit and an image analysis unit, which is used to capture external images, and after interpretation, transmit the judgment results to the signal transmitting mechanism. The signal transmitting mechanism has a built-in transmitter that can send command signals wirelessly, such as Bluetooth, radio frequency (RF), and infrared (IR) transmitters, etc., for wirelessly sending command signals to the preset target. The target is equipped with a signal receiver. When receiving a command signal, it can perform predetermined actions to achieve the effect of wireless image recognition and intelligent remote control.

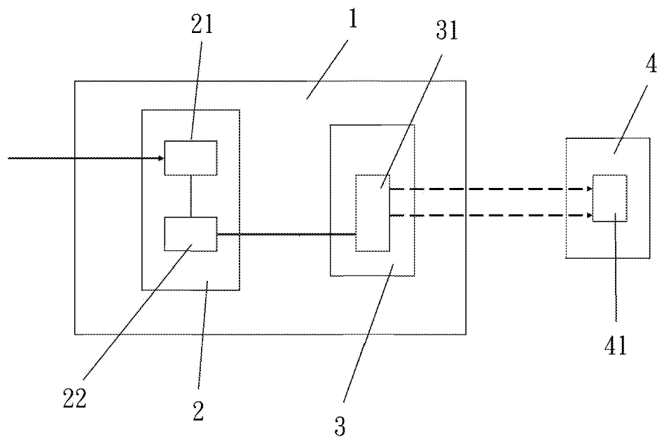

### FIELD OF THE INVENTION

The present invention relates to a smart wireless remote-control device with image recognition function, which is characterized by using an intelligent recognition device to capture external images for judgment, transmit the results to a wireless remote-control device, and issue command signals to cause the target to generate corresponding.

### BACKGROUND

The conventional wireless remote-control device mainly uses its built-in signal transmitting unit to send out a signal to activate or deactivate the target, such as TV, air conditioner, fan, etc. Although it has the function of wireless remote control, it still needs to rely on human manual control during operation by pressing the button on the remote control with his finger to control the target object. In addition, since the general remote control is a separate object, users often place it arbitrarily after operation, and there is a dilemma that it usually cannot be found when it is to be used. Furthermore, the buttons of the conventional remote control would often become damaged and dirty after a period of use, resulting in poor remote control or time contact for disinfection, so there should be obviously improved.

### BRIEF DESCRIPTION

The present invention is a smart wireless remote-control device with image recognition function. The remote-control device mainly includes an image recognition mechanism, which is electrically connected to a signal transmission mechanism. The image recognition mechanism is composed of a camera lens unit and an image analysis unit, which is used to capture external images, and after interpretation, transmit the judgment results to the signal transmitting mechanism. The signal transmitting mechanism has a built-in transmitter that can send command signals wirelessly, such as Bluetooth, radio frequency (RF), and infrared (IR) transmitters, etc., for wirelessly sending command signals to the preset target. The target is equipped with a signal receiver. When receiving a command signal, it can perform predetermined actions to achieve the effect of wireless image recognition and intelligent remote control.

### DRAWINGS

The FIGURE is a schematic diagram of the present invention.

### DETAILED DESCRIPTION OF THE INVENTION

Please refer to the FIGURE, the present invention relates to a smart wireless remote-control device 1 with image recognition function. The wireless remote-control device 1 is mainly composed of an image recognition mechanism 2 and a signal transmission mechanism 3, both of which are connected electrically. The image recognition mechanism 2 includes a camera lens unit 21 and an image analysis unit 22, which are used to capture external images, such as human figures, gestures, faces, or image information such as specific sizes and directions, and analyze and interpret them. And then send the judgment result to the signal transmitting mechanism 3. The signal transmitting mechanism 3 has a built-in transmitter 31 that can remit command signals wirelessly, such as Bluetooth (BT), radio frequency (RF), and infrared (IR) transmitters, etc., for wirelessly remitting command signals to the target 4. The target 4 is provided with a signal receiver 41, which can perform a predetermined action when receiving an instruction signal from the transmitter 31.

According to the above description, the smart wireless remote control device 1 completed in this invention can provide the use of receiving external images, react immediately, and make the target perform predetermined functional actions by remote control, without the need for the user to make additional judgments, and then press the button with the finger to operate, that achieves the effect of intelligent wireless remote and obtains extremely high progress.

In application, the present invention can be installed on a variety of electrical appliances, such as air conditioners, TVs, automatic flushing systems, and even security devices used as access control. The method is that a comparison data file is built in the image recognition mechanism 2. When the camera lens unit 21 obtains an external image, after the image analysis unit 22 is compared with the database, the corresponding command can be sent to the signal transmission mechanism 3. Therefore, the signal transmitting mechanism 3 sends a wireless signal to the target from the built-in transmitter 31 according to the instruction to make the target 4 turning on and off the power supply, changing the operation mode, etc. The wireless signal may include but is not limited to Bluetooth, radio frequency (RF), and infrared (IR), etc. Taking the application of security devices for access control as an example, this invention can be installed outside the gate. When a qualified image is approaching, it is judged to be correct through identification, and an instruction to open the door is issued, so that the gate is automatically unlocked and opened. If the external image does not meet the qualifications, a warning signal can be issued, which can be a general beeping sound, or transmitted to the user's mobile phone or other receiver to let the user know that an unknown person is approaching. It is understood that the present invention achieves the function of intelligent wireless remote control and has significant progress.

In conclusion, the smart wireless remote-control device 1 of the present invention is an independent and single structure, which is convenient to be installed in any position, and can be suitable for the needs of different places and various targets. And after identification, through wireless remote control, the target can be activated to perform predetermined actions, and the effect of multiple functions can be obtained. Meanwhile, the operator does not need to actually press the button by hand, which can not only avoid the risk of contact, but also reduce the aging and damage of the button or poor contact and obtains a practical improvement.

I claim:

1. A smart wireless remote control device with image recognition function including an image recognition mechanism, which is electrically connected to a signal transmission mechanism, in which
the image recognition mechanism being composed of a camera lens unit and an image analysis unit, which is used to capture external images, and after interpretation, transmit the judgment results to the signal transmitting mechanism,
the signal transmitting mechanism having a built-in transmitter that can send command signals wirelessly for wirelessly sending command signals.

2. The smart wireless remote-control device with image recognition function as claimed in claim 1, wherein the image recognition mechanism is provided with a built-in image database for discrimination.

3. The smart wireless remote-control device with image recognition function as claimed in claim 1, wherein the transmitter in the signal transmitting mechanism can be a Bluetooth, radio frequency, or infrared transmitter.
